(19) United States
(12) Patent Application Publication
(10) Pub. No.: US 2011/0064905 A1
(43) Pub. Date: Mar. 17, 2011

(54) Decorative Member for a Barrier

(75) Inventor: Alan Zhu, Jiangsu (CN)

(73) Assignee: WUXI DIF TECHNOLOGY CO., LTD., Wuxi, Jiangsu (CN)

(21) Appl. No.: 12/530,407

(22) PCT Filed: Jun. 15, 2007
(86) PCT No.: PCT/CN07/01884

§ 371 Date: Dec. 6, 2010

(30) Foreign Application Priority Data
Mar. 5, 2007 (CN) 200710020486.5

(51) Int. Cl. B32B 3/06

(52) U.S. Cl. 428/99

(57) ABSTRACT

A decorative member for a barrier, comprises at least two bodies of decorative member and a connecting element for connecting two adjacent bodies of decorative member together, in which, the two ends of the connecting element are respectively connected to the bodies of decorative member. The connecting element has a mounting notch and a connecting cover board. One side of the connecting cover board connects with two side areas of the mounting notch of the connecting element.

### FIELD OF THE INVENTION

The present invention relates to a decorative member for a barrier.

### BACKGROUND OF THE INVENTION

Generally, the decorative member on a traditional fence is formed by welding. In the manufacturing process, the anticorrosive coating on the raw material is damaged, as might cause rustiness in the future. The process time is long and the decorative member can not be changed once welded. The interposed decorative member adopted afterward has a limitation for the versatility of products and is not beneficial for storage and transportation.

### SUMMARY OF THE INVENTION

The object of the present invention is to provide decorative member for a barrier with convenient installation and employment, and capability of being interchanged.

To acheive the object, the decorative member for a barrier according to the present invention comprises at least two bodies of decorative member. A connecting element is arranged between adjacent bodies of decorative member. Two ends of the connecting element are respectively connected with the bodies of decorative member. A mounting notch and a connecting cover board are arranged on said connecting element. One surface of the connecting cover board is connected with opposite side areas of the mounting notch of the connecting element.

The respective connection between two ends of one surface of the connecting cover board and side areas of the mounting notch of the connecting element is plug-in connection. The two side areas of the mounting notch can be rectangular shrinkage pools and T-shape grooves. Two ends of the connecting cover board are accordingly provided with rectangular heaves or T-shape heaves.

Connection between one surface of the connecting cover board and two side areas of the mounting notch of the connecting element can also be a transverse embedded connection; the two side areas of the mounting notch can be dovetail type grooves; two ends of the connecting cover board are accordingly provided with dovetail type heaves.

Inside calipers can be also arranged in the shrinkage pools of two side areas of the mounting notch on the body of decorative member., which is attached to the heave on the covering cover board.

The structure of the present invention avoids the damage of the anticorrosive coating of the fence caused by welding and the latent danger of rustiness, and protects the surface of the fence; besides, the decorative member of the present invention can be installed on spot, thus is convenient for installation, employment, storage, transportation, and is capable of interchange.

### BRIEF DESCRIPTION OF THE DRAWINGS

FIG. 1 is a front view of the body of decorative member of the first embodiment of the present invention;

FIG. 2 is a top view of FIG. 1;

FIG. 3 is a front view of the cover board of the present invention fit for FIG. 1;

FIG. 4 is a left view of FIG. 3;

FIG. 5 is a front view of the body of decorative member of the second embodiment of the present invention;

FIG. 6 is a top view of FIG. 5;

FIG. 7 is a front view of the cover board of the present invention fit for FIG. 5;

FIG. 8 is a left view of FIG. 7;

FIG. 9 is a front view of the body of decorative member of the third embodiment of the present invention;

FIG. 10 is a left view of FIG. 9;

FIG. 11 is a top view of FIG. 9;

FIG. 12 is a front view of the cover board of the present invention fit for FIG. 9;

FIG. 13 is a left view of FIG. 12;

FIG. 14 is a front view of the body of decorative member of the fourth embodiment of the present invention;

FIG. 15 is a left view of FIG. 14;

FIG. 16 is a top view of FIG. 14;

FIG. 17 is a front view of the cover board of the present invention fit for FIG. 14;

FIG. 18 is a left view of FIG. 17;

FIG. 19 is a enlarged partial view of FIG. 15;

FIG. 20 is a front view of the second shape of the body of decorative member of the present invention;

FIG. 21 is a front view of the third shape of the body of decorative member of the present invention;

FIG. 22 is a perspective view of the combination of the body of decorative member and the fence of the present invention.

### EMBODIMENTS

The present invention will be further illustrated according to the attached drawings.

### Embodiment 1

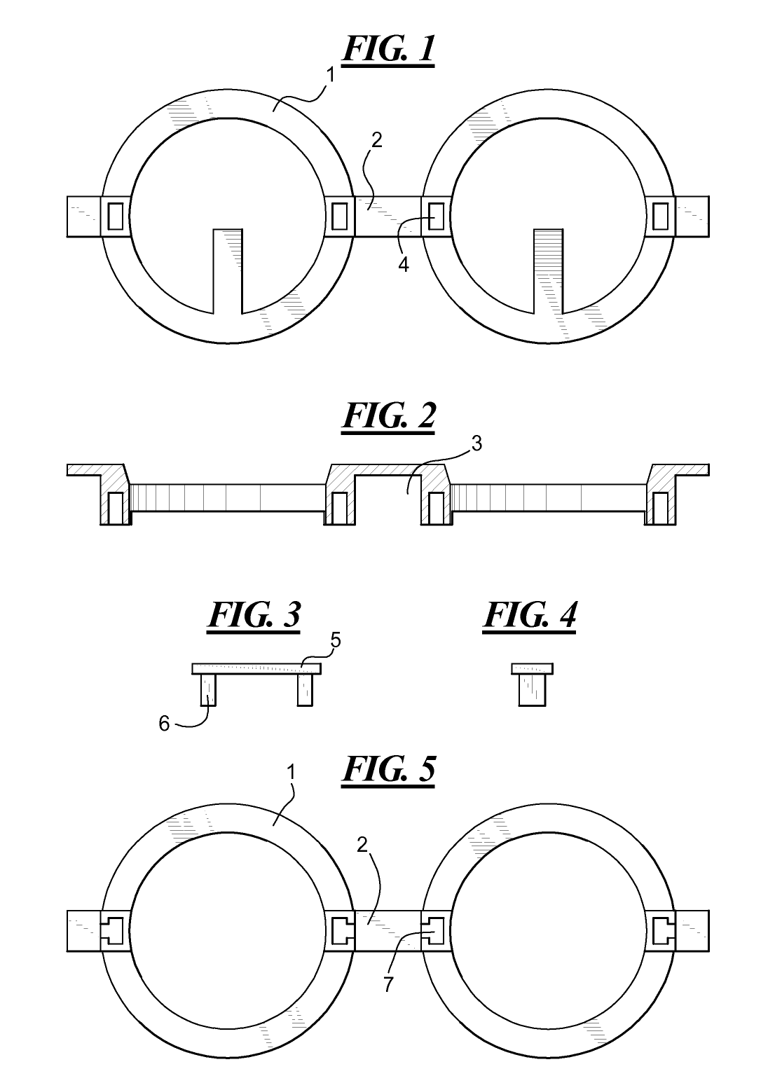

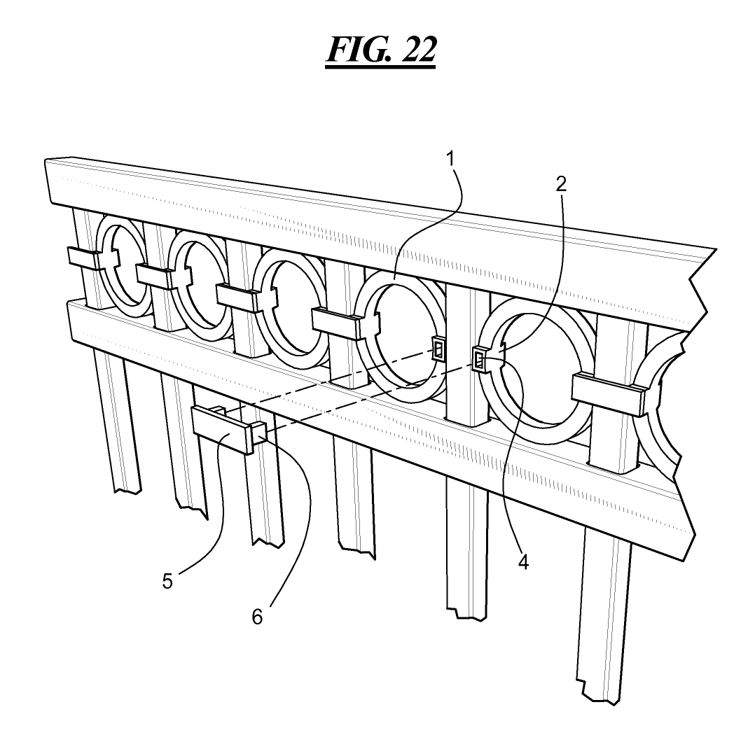

In FIG. 1-FIG. 4, the decorative member for a barrier comprises at least two bodies of decorative member 1; a connecting element 2 is arranged between two adjacent bodies; two ends of the connecting element are respectively connected with body 1; a mounting notch 3 for installing the fence is arranged on the connecting piece 2; two rectangular shrinkage pools 4 are arranged on two sides of the mounting notch 3; after being installed in the mounting notch 3, the fence is covered with a cover board 5 provided with two rectangular heaves 6 on two ends; the two rectangular heaves 6 are inserted into the rectangular shrinkage pools 4, which are in close fit; between the cover board and the fence, a self-tapping screw can also be screwed, thus the decorative member for a barrier is well connected with the fence, as can be seen in FIG. 22.

### Embodiment 2

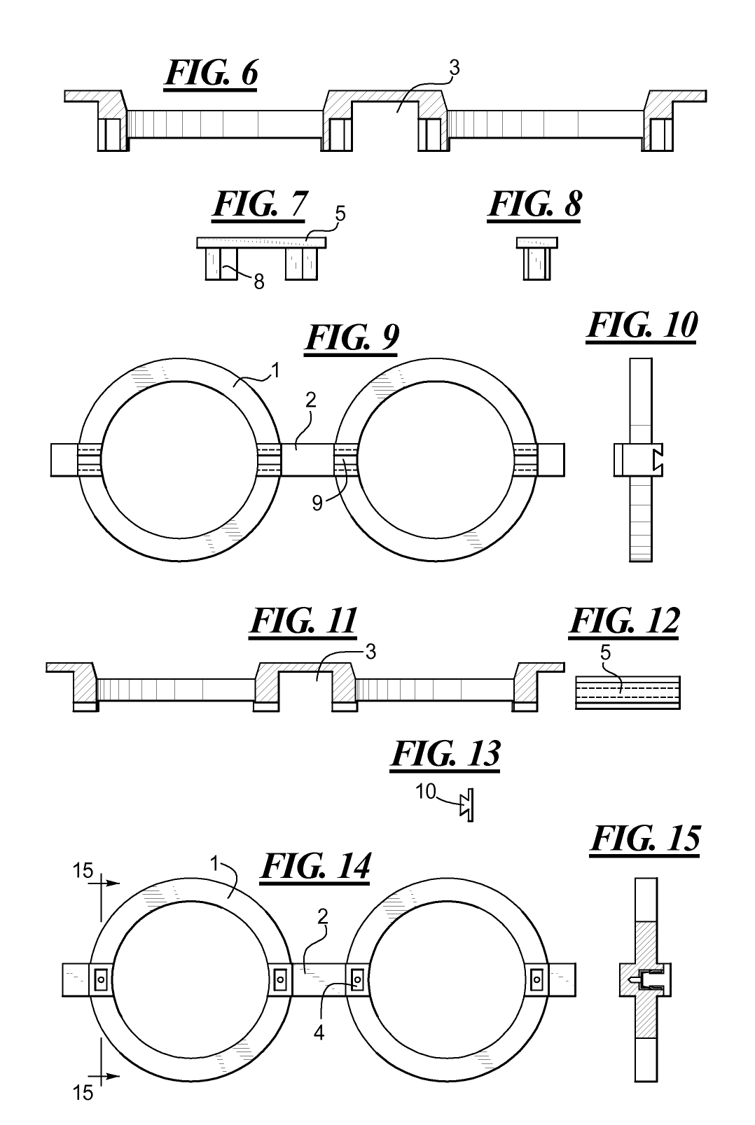

In FIG. 5-FIG. 8, the decorative member for a barrier comprises at least two bodies of decorative member 1; the connecting element 2 is arranged between two adjacent bodies; two ends of the connecting element are respectively connected with body 1; the mounting notch 3 for installing the fence is arranged on the connecting element 2; two T-shape grooves 7 are arranged on two sides of the mounting notch 3; after being installed in the mounting notch 3, the fence is covered with a cover board 5 provided with two T-shape heaves 8 on two ends; the two T-shape heaves 8 are inserted into the T-shaped grooves 7; between the cover plate and the fence, a self-tapping screw can also be screwed, thus the decorative member for a barrier is well connected with the fence.

### Embodiment 3

In FIG. 9-FIG. 13, the decorative member for a barrier comprises at least two bodies of decorative member 1; the connecting element 2 is arranged between two adjacent bodies; two ends of the connecting element are respectively connected with body 1; the mounting notch 3 for installing the fence is arranged on the connecting element 2; two dovetail type grooves 9 are arranged on two sides of the mounting notch 3; after being installed in the mounting notch 3, the fence is covered with a cover board 5 provided with a dovetail type heave 10 on one side; the dovetail type heave 10 is transversely inserted into the dovetail type groove 9, thus the decorative member for a barrier is well connected with the fence.

### Embodiment 4

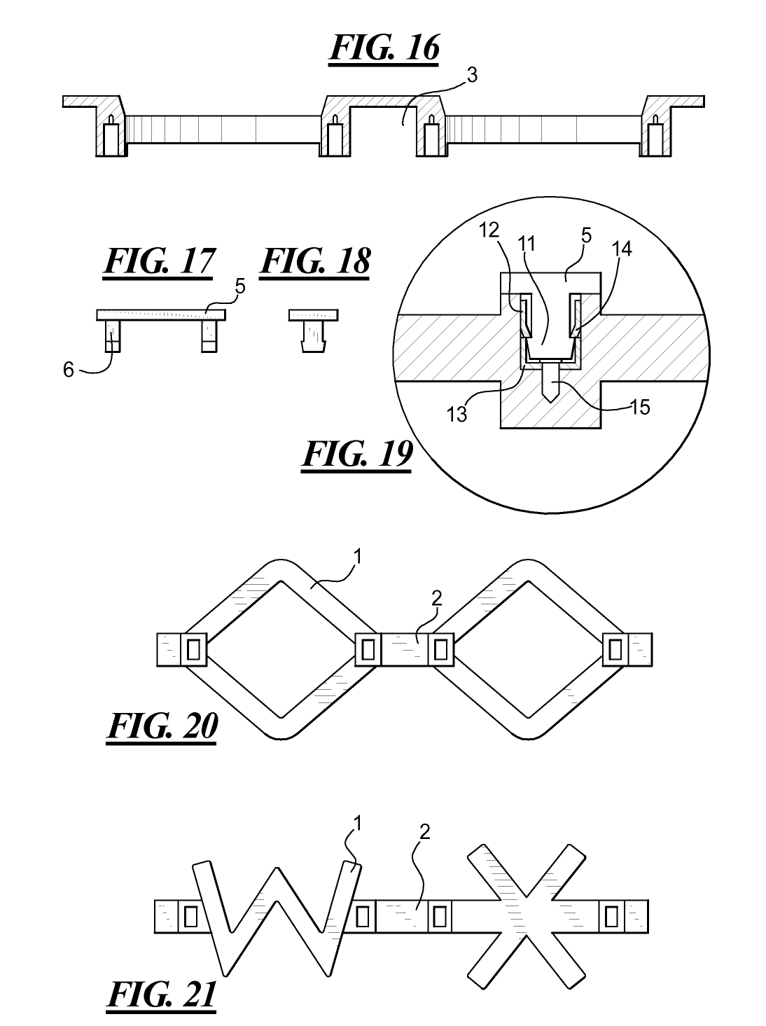

In FIG. 14-FIG. 19, the decorative member for a barrier comprises at least two bodies of decorative member 1; the connecting element 2 is arranged between two adjacent bodies; two ends of the connecting element are respectively connected with body 1; the mounting notch 3 for installing the fence is arranged on the connecting element 2; two rectangular shrinkage pools 4 of two sides of the mounting notch 3 for installing the fence are provided with two inside calipers 13 which can be fixed in the shrinkage pools 4 with screw 5; the fence is installed in the mounting notch 3, which is then covered with the cover plate 5 provided with two reversed T-shape heaves 11 on two ends; the circular bead 12 of the two reversed T-shaped heaves 11 is back off by two elastic claws 14 of the inside calipers 13 after the heave 11 is inserted into the rectangular shrinkage pool 4, thus the decorative member for a barrier can be well connected with the fence.

In above embodiments, the shape of the body of decorative member can also be a rhombus as shown in FIG. 20. As shown in FIG. 21, the body on one side of the connecting element 2 is in a shape of ‘W’, and the other is in a shape of ‘*’. The body of decorative member can also be other various shapes.

1. The decorative member for a barrier comprises at least two bodies of decorative member, wherein, a connecting element is arranged between adjacent bodies of decorative member, two ends of connecting element are respectively connected with the bodies of decorative member; a mounting notch is arranged on the connecting element; a connecting cover board, one side of which is connected with two side areas of the mounting notch of the connecting element.

2. The decorative member for a barrier according to claim 1, wherein, the connection between two ends of one surface of the connecting cover board and two side areas of the mounting notch of the connecting element is plug-in connection.

3. The decorative member for a barrier according claim 2, wherein, a rectangular heave is arranged on two ends of one surface of the connecting cover board; two side areas of the mounting notch of the connecting element are rectangular shrinkage pools which are attached to a rectangular heave.

4. The decorative member for a barrier according to claim 2, wherein, T-shape heaves are arranged on two ends of the connecting cover board; two side areas of the mounting notch of the connecting element are T-shape grooves which are attached to the T-shape heaves.

5. The decorative member for a barrier according to claim 1, wherein, the connection between one surface of the connecting cover board and two side areas of the mounting notch of the connecting piece is transversely embedded connection.

6. The decorative member for a barrier according to claim 5, wherein, a dovetail type heave is arranged on one surface of the connecting cover board; two side areas of the mounting notch of the connecting piece are dovetail type grooves which are connected with the dovetail type heave in a transversely embedded connection.

7. The decorative member for a barrier according to claim 2, wherein, reversed T-shape heaves are arranged on two ends of one surface of the connecting cover board; two side areas of the mounting notch of the connecting element are rectangular shrinkage pools; inside calipers are also arranged in the rectangular shrinkage pools; jaws of the inside calipers are back off with the circular bead of the reversed T-shape heaves.
